(19) United States
(12) Patent Application Publication
(10) Pub. No.: US 2017/0270436 A1
(43) Pub. Date: Sep. 21, 2017

(54) RESERVATION AND NOTIFICATION SYSTEM AND METHOD USING MOBILE COMMUNICATION DEVICE

(71) Applicant: Pei-Ling Fang, Changhua County (TW)

(72) Inventors: Pei-Ling Fang, Changhua County (TW); Chien-Hung Lin, Taichung City (TW); Meng-Ching Lin, Taoyuan City (TW); Hsin-Yu Li, Kaohsiung City (TW); Yu-Nan Wei, Taichung City (TW); Hung-Jen Syu, Changhua County (TW); Pin-Hsiao Lin, Taichung City (TW); Ching-Yang Li, Taichung City (TW)

(21) Appl. No.: 15/072,365

(22) Filed: Mar. 17, 2016

(51) Int. Cl. G06Q 10/02; H04W 4/00; G06Q 30/02

(52) U.S. Cl. CPC G06Q 10/02; G06Q 30/0281; H04W 4/008; H04W 88/02

(57) ABSTRACT

The reservation and notification system contains a ticketing device at a consumer site and a mobile communication device carried by a customer for interaction with the ticketing device. The ticketing device radiates signals and the mobile communication device, when the customer enters the consumer site, senses and receives signals from the ticketing device. A processing device allows the customer to make a reservation at a specific time calculated by the processing device according to the number of customers waiting. Once the customer confirm the reservation, the processing device issues an electronic ticket. The processing device then notifies the customer some time before the reservation period to return to the consumer site. After validating the electronic ticket, the customer is allowed to access the consumer site, thereby saving the time waiting in line.

### BACKGROUND OF THE INVENTION

(a) Technical Field of the Invention

The present invention is generally related to ticketing devices, and more particular to a reservation and notification system and method, through the interaction between mobile communication devices and a ticketing device, capable of saving customers' trouble in waiting in line.

(b) Description of the Prior Art

When people visit an amusement park, usually significant amount of time is wasted in crowded and chaotic lines for popular attractions or rides. On the other hand, at a restaurant and food court, usually there is a take-a-number or ticketing device allowing customers to reserve a place in line. However, the take-a-number device usually lacks notification function and, unless a customer shows up at the right moment, he or she still has to wait nearby, crowding the vicinity of the restaurant or food court. In addition, the take-a-number device wastes paper and is not environmentally friendly.

### SUMMARY OF THE INVENTION

A major objective of the present invention is therefore to provide a reservation and notification system and a related method where a mobile communication device of a consumer interacts with a ticketing device of a consumer site so as to save the time waiting in line and to avoid crowdedness at the consumer site.

The reservation and notification system contains a ticketing device at a consumer site, a mobile communication device carried by a customer for interaction with the ticketing device, and a processing device. The ticketing device transmits a signal and the mobile communication device, when the customer enters the consumer site, senses and receives the signal from the ticketing device. The mobile communication device interacts with the processing device to make a reservation within a reservation period. The processing device notifies the customer some time before the reservation period to return to the consumer site, thereby saving the time waiting in line.

The mobile communication device can be a smart phone, a smart watch, or a tablet (e.g., iPad).

The interaction between the mobile communication device and the ticketing device is through Bluetooth.

The signal is an identity information of the ticketing device. The interaction between the mobile communication device and the processing involves the mobile communication device's sending the identity information to the processing device and the processing device's sending the reservation period and an electronic ticket to the mobile communication device, both through Internet.

The process device is a cloud server.

The processing device obtains the reservation period according to a number of customers having already making reservation and not yet fulfilling and cancelling reservation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a scheme diagram showing a reservation and notification system according to an embodiment of the present invention.

FIG. 2 is a functional block diagram showing the reservation and notification system of FIG. 1.

FIG. 3 is a flow diagram showing the reservation and notification method of an embodiment of the present invention.

FIG. 4 is another flow diagram showing the reservation and notification method of an embodiment of the present invention.

FIGS. 5 to 17 provide an operation scenario of the reservation and notification system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

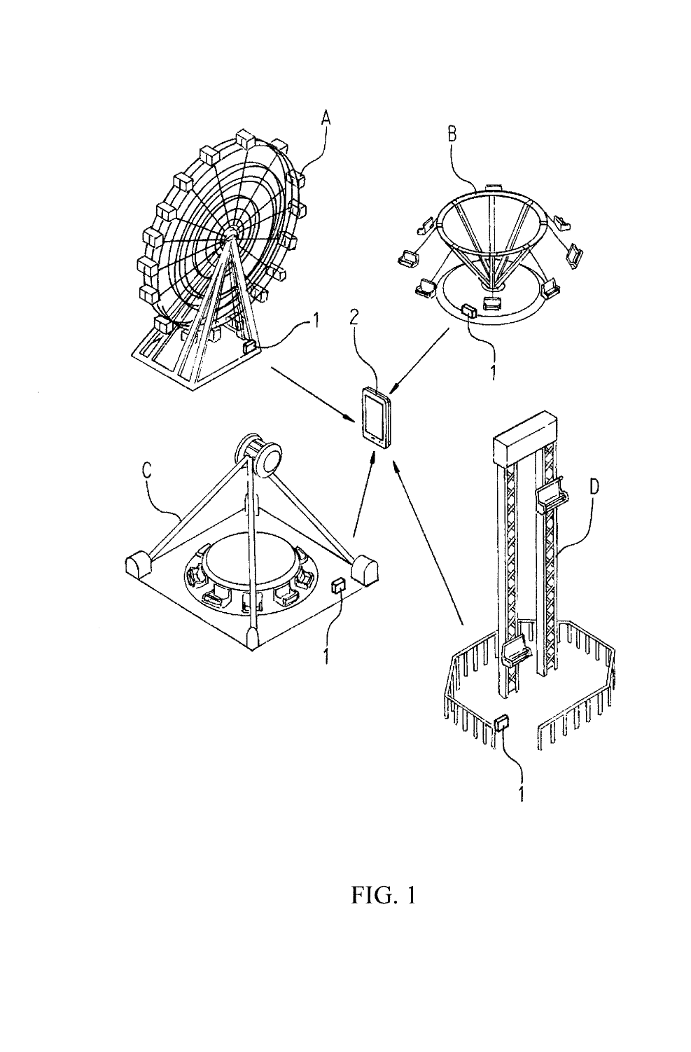

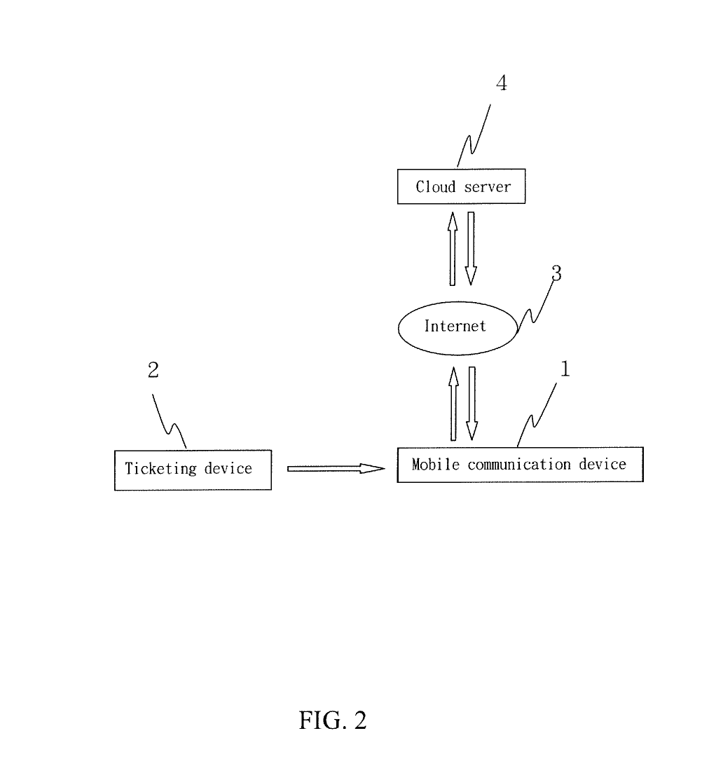

As shown in FIGS. 1 and 2, a reservation and notification system according to an embodiment of the present invention contains a ticketing device 1 configured at a consumer site and a mobile communication device 2 carried by a customer for interaction with the ticketing device 1. The ticketing device 1 is capable of transmitting a signal and the mobile communication device 2 is capable of sensing and receiving the signal. The reservation and notification system further contains a processing device 4 for interaction with the mobile communication device 2 through Internet 3 to make a reservation at the consumer site and issue an electronic ticket to the mobile communication device 2. Therefore, when a customer carrying the mobile communication device 2 enters a consumer site, the customer is able to make a reservation using the mobile communication device 2. After the mobile communication device 2 receives the electronic ticket, the processing device 4 will notify the mobile communication device 2 at a proper moment so that the customer can return to the consumer site in time. At the consumer site, after validating the electronic ticket, the customer then is allowed to access the consumer site, thereby saving a lot of time waiting in line and avoiding crowdedness around the consumer site.

The interaction between the ticketing device 1 and the mobile communication device 2 is through a wireless interface using, for example, Bluetooth.

The interaction between the mobile communication device 2 and the ticketing device 1 involves the mobile communication device 2 obtaining an identity information of the ticketing device 1 from the signal transmitted by the ticketing device 1.

The interaction between the mobile communication device 2 and the processing device 4 through Internet 3 involves the mobile communication device 2 submitting the identity information to the processing device 4, and the processing device 4 returning a reservation period and an electronic ticket.

In the present embodiment, each recreation facility A, B, C, or D of an amusement park is configured with a ticketing device 1. When a customer enters the recreation facility A, B, C, or D, a mobile communication device 2 of the customer senses and receives an identity information of the ticketing device 1 from the ticketing device 1. The mobile communication device 2 then accesses the processing device 4 through Internet 3 and submits the identity information. The processing device 4 calculates the number of customers already making reservation and not yet fulfilling and cancelling reservation.

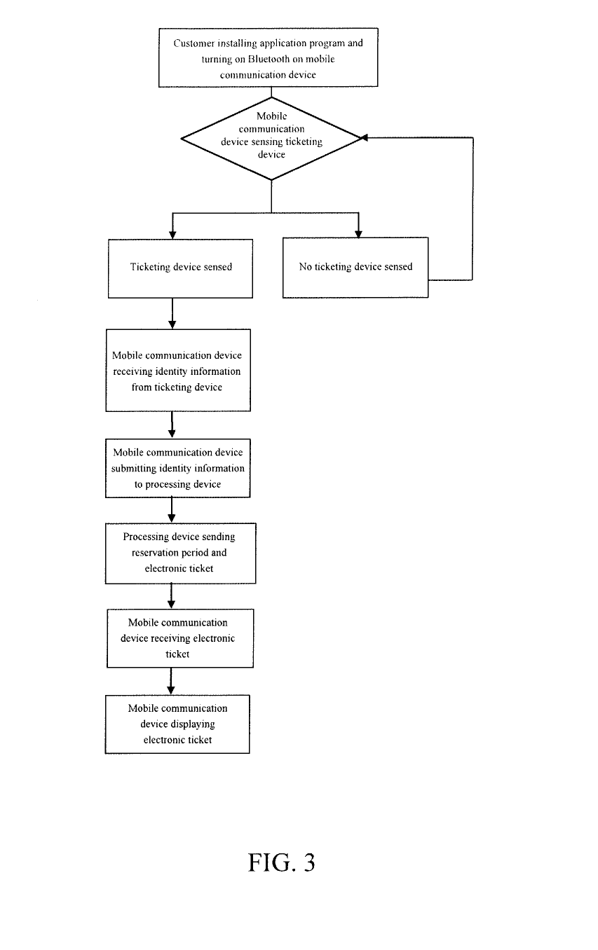

As shown in FIG. 3, a reservation and notification method according to an embodiment of the present invention contains the following steps.

Firstly, a customer installs a ticketing application program on a mobile communication device 2 and turns on the mobile communication device 2's Bluetooth function.

Secondly, when the customer reaches a consumer site equipped with a ticketing device 1, the mobile communication device 2 receives an identity information of the ticketing device 1 from the ticketing device 1.

If the consumer site is not equipped with a ticketing device 1, the mobile communication device 2 will continue to search for the ticketing device 1 and the method does not proceed to the next step.

Thirdly, the mobile communication device 2 accesses the processing device 4 through Internet 3 and submits the identity information.

Fourthly, the processing device 4 transmits a reservation period to the mobile communication device 2.

Fifthly, once the mobile communication device 2 confirms to make a reservation, the mobile communication device 2 receives and displays an electronic ticket, and completes the reservation.

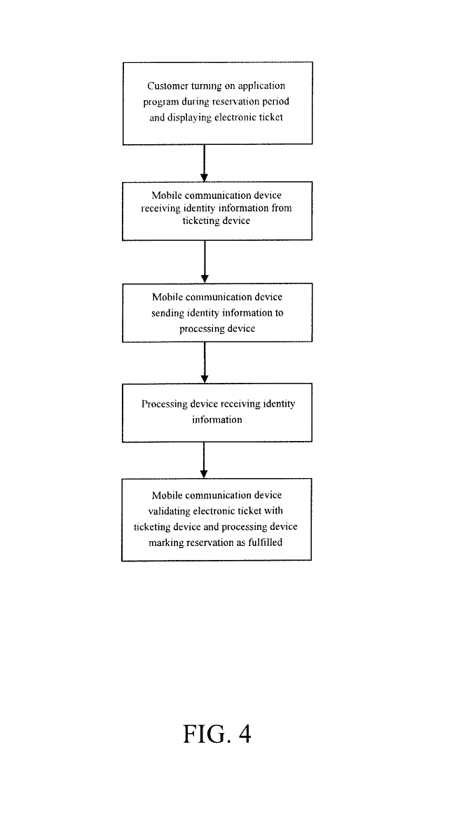

As shown in FIG. 4, the reservation and notification method further contains the following steps after customer has returned to the consumer site.

Firstly, the customer turns on the ticketing application program of the mobile communication device during the reservation period and approaches the ticketing device 1.

Secondly, the mobile communication device 2 receives the identity information of the ticketing device 1 from the ticketing device 1.

Thirdly, the mobile communication device 2 sends the identity information to the processing device 4.

Fourthly, the processing device 4 receives the identity information.

Fifthly, the mobile communication device 2 validates the electronic ticket with the ticketing device 1 and the processing device marks the reservation as fulfilled.

As described above, the customer therefore does not need to wait in a line and can leave the recreation facility A, B, C, or D and tours the other part of the amusement park. The recreation facility A, B, C, or D therefore is not crowded by waiting customers. The customer then returns to the recreation facility A, B, C, or D after receiving notification. After validating the electronic ticket with the ticketing device 1 and communicating with the processing device 4 to fulfill the reservation, the customer can access the recreation facility.

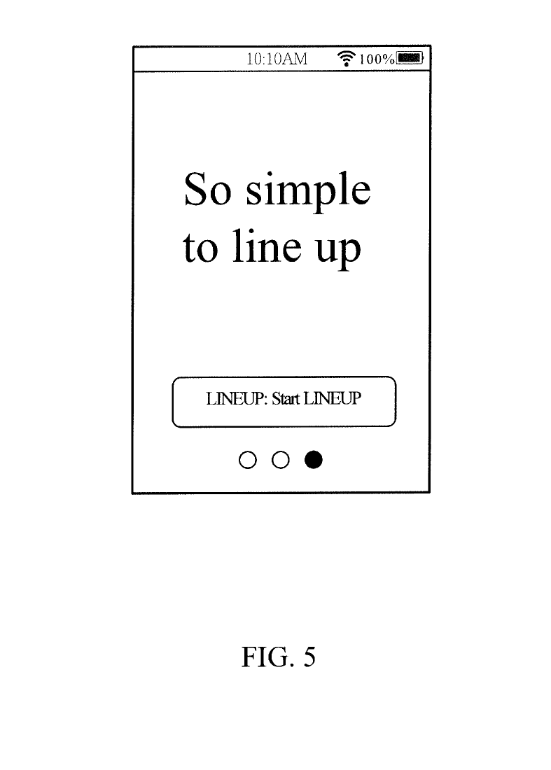

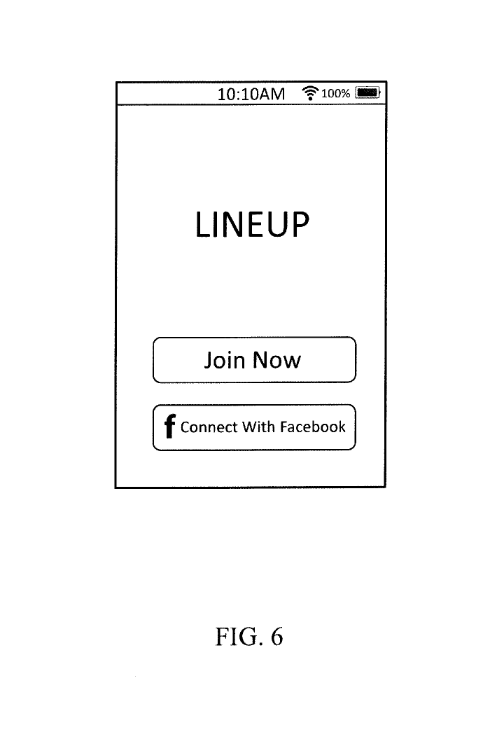

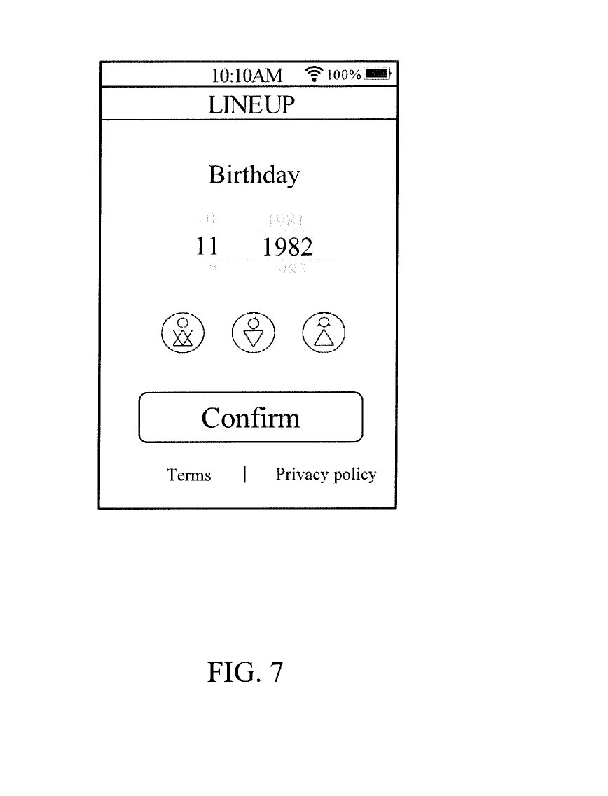

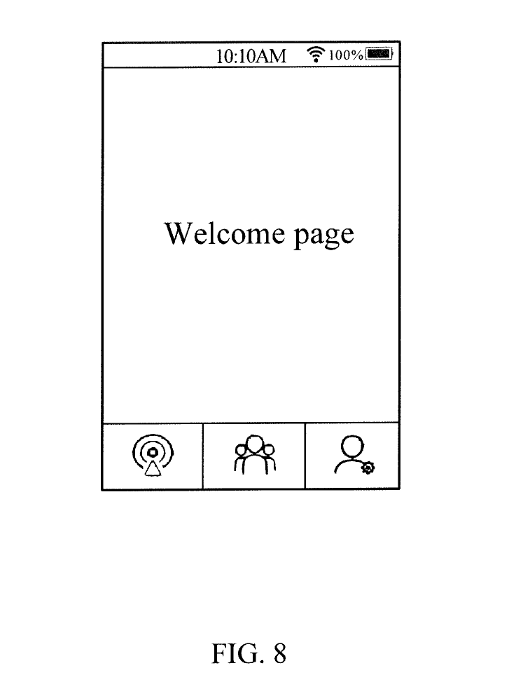

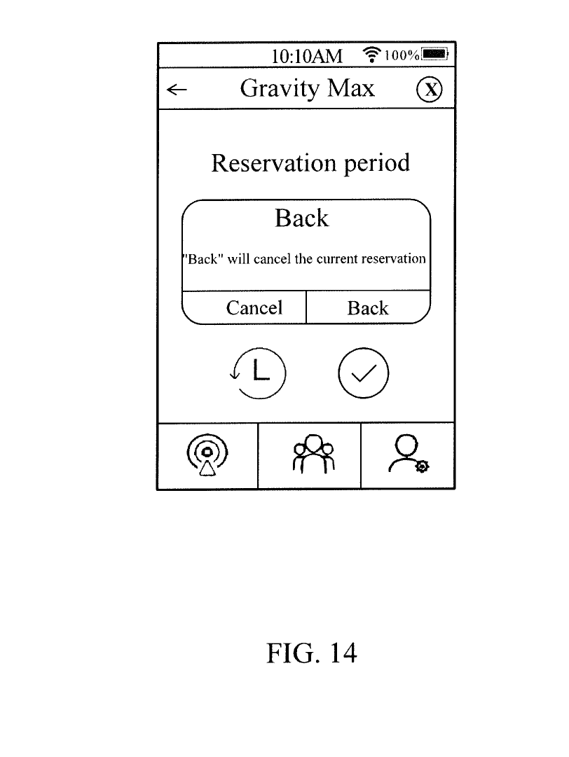

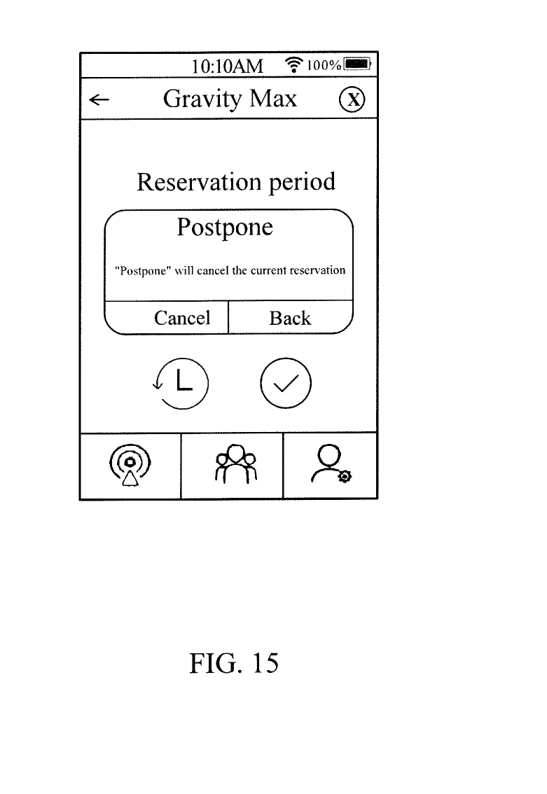

In order to understand more clearly about the present invention, using an amusement park as example as shown in FIGS. 5 to 17, the present invention involves the following operations.

As shown in FIGS. 5 to 8, a customer turns on the ticketing application program installed on a mobile communication device 2.

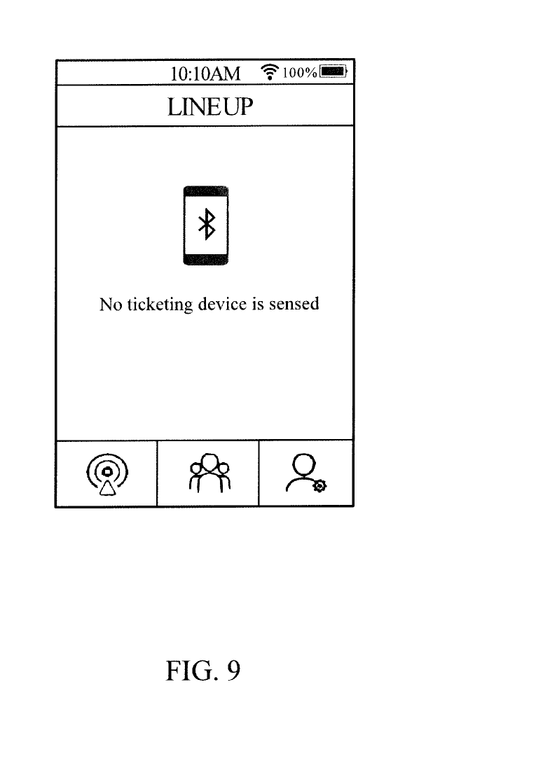

Then, as shown in FIG. 9, when the customer enters a recreation facility (i.e., consumer site), the mobile communication device 2 scans for a ticketing device 1. If none is sensed, the mobile communication device 2 displays a “No ticketing device is sensed” message.

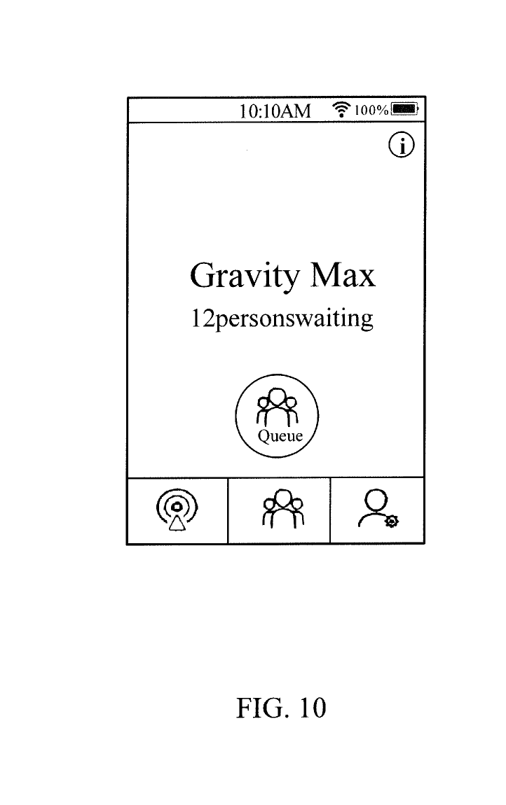

As shown in FIG. 10, when the mobile communication device 2 detects a ticketing device 1, the mobile communication devices 2 displays a message indicating a name of the recreation facility and the number of people currently waiting.

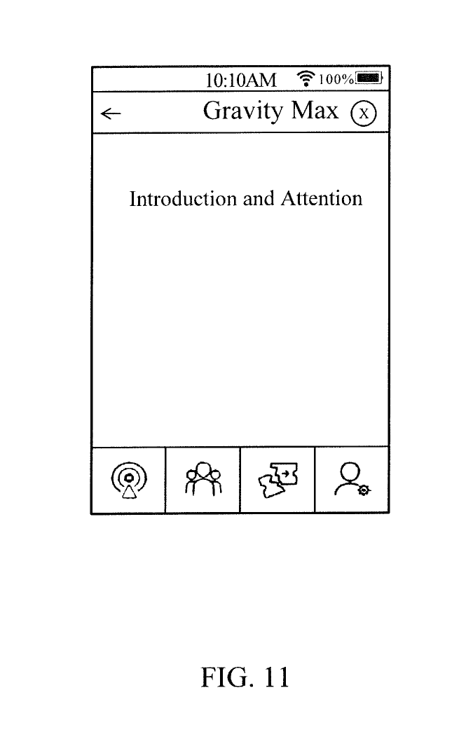

As shown in FIG. 11, the mobile communication device 2 is able to show introduction and attention of the recreation facility.

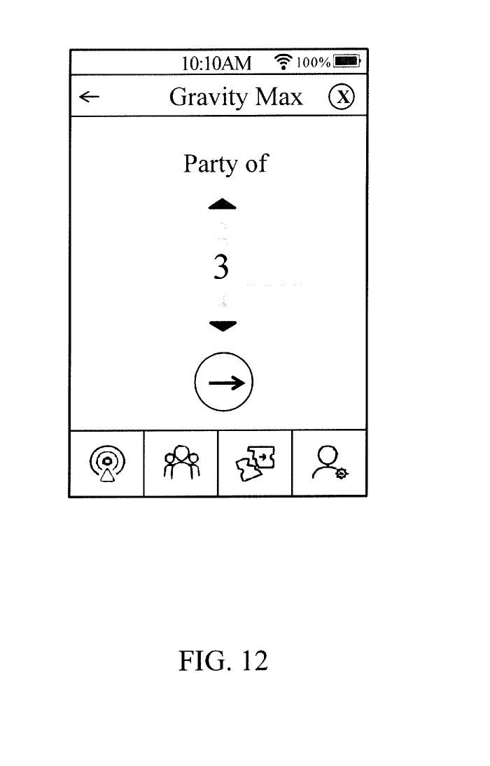

Then, as shown in FIG. 12, the customer is requested to enter the number of persons of his/her party if the customer is interested in waiting in line.

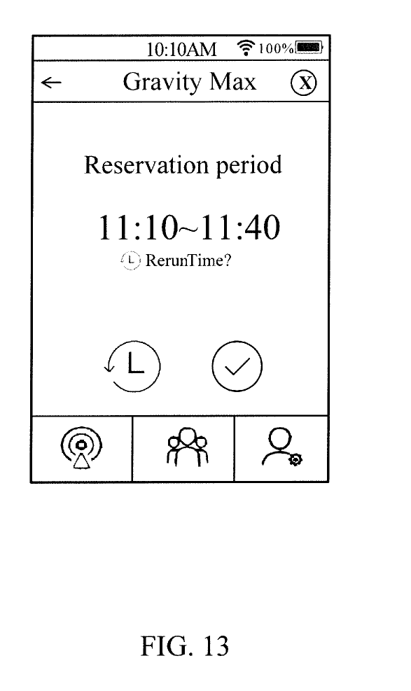

As shown in FIGS. 13 to 15, the mobile communication device 2 shows an estimated period when it is the customer's turn to use the recreation facility. At this point, the customer can confirm a reservation, cancel the reservation if the customer decides not to wait, or postpone the reservation, by engaging various buttons on the mobile communication device 2.

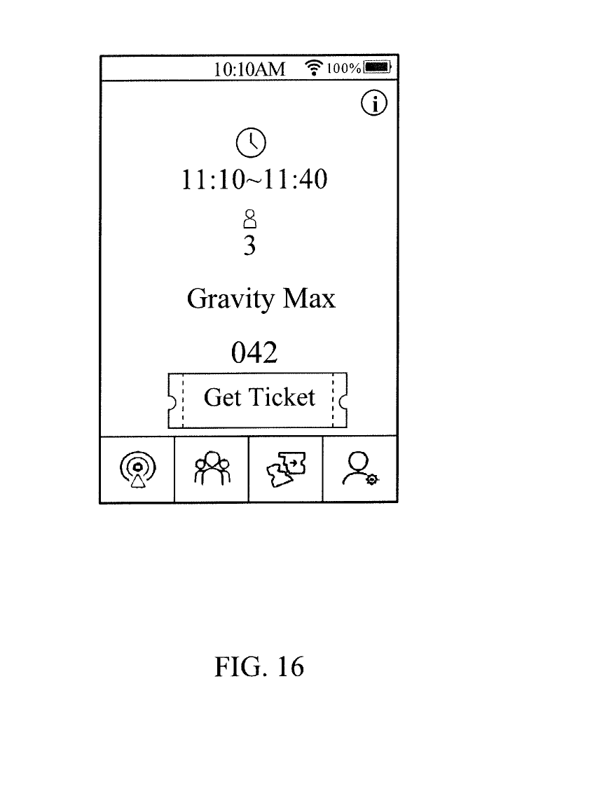

As shown in FIG. 16, the mobile communication device 2 receives an electronic ticket and displays the electronic ticket.

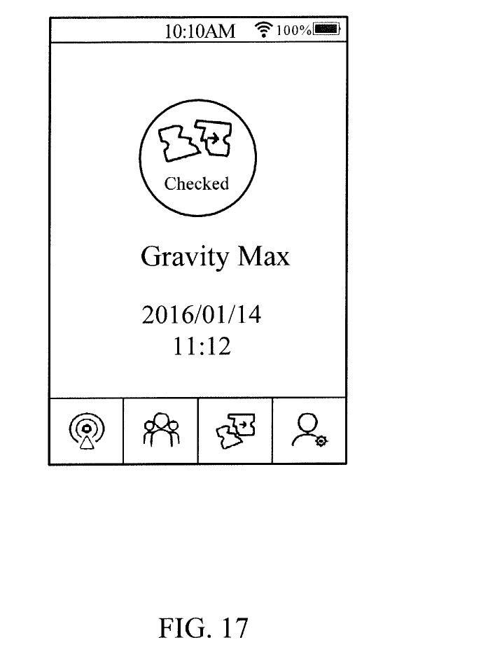

As shown in FIG. 17, before the reservation period, the customer is alerted by processing device 4 through Internet 3 and the mobile communication device 2 to return to the recreation facility to access the recreation facility.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A reservation and notification system comprising:
a ticketing device at a consumer site;
a mobile communication device carried by a customer for interaction with the ticketing device; and
a processing device;
wherein the ticketing device transmits a signal and the mobile communication device, when the customer enters the consumer site, senses and receives the signal from the ticketing device;
the mobile communication device interacts with the processing device to make a reservation at a reservation period;
the processing device notifies the customer some time before the reservation period to return to the consumer site, thereby saving the time waiting in line.

2. The reservation and notification system according to claim 1, wherein the mobile communication device is one of a smart phone, a smart watch, and a tablet.

3. The reservation and notification system according to claim 1, wherein the interaction between the mobile communication device and the ticketing device is through Bluetooth.

4. The reservation and notification system according to claim 1, wherein the signal is an identity information of the ticketing device; the interaction between the mobile communication device and the processing comprising the mobile communication device's sending the identity information to the processing device and the processing device's sending the reservation period and an electronic ticket to the mobile communication device, both through Internet.

5. The reservation and notification system according to claim 4, wherein the process device is a cloud server.

6. The reservation and notification system according to claim 4, wherein the processing device obtains the reservation period according to a number of customers having already making reservation and not yet fulfilling and cancelling reservation.

7. A reservation and notification method comprising the steps of:
a customer installing a ticketing application program on a mobile communication device and turning on the mobile communication device's Bluetooth function;
when the customer reaches a consumer site equipped with a ticketing device, the ticketing device sending an identity information of the ticketing device to the mobile communication device;
the mobile communication device accessing a processing device through Internet and submitting the identity information;
the processing device transmitting a reservation period to the mobile communication device;
once the mobile communication device confirming to make a reservation, the mobile communication device receiving and displaying an electronic ticket from the processing device;
the processing device notifying the mobile communication device before the reservation period to return to the consumer site;
the customer approaching the mobile communication device during the reservation period to the ticketing device;
the mobile communication device receiving the identity information of the ticketing device and sending the identity information to the processing device; and
the mobile communication device validates the electronic ticket with the ticketing device.

8. The reservation and notification method according to claim 7, wherein, if the consumer site is not equipped with a ticketing device, the mobile communication device continue to search for a ticketing device and does not proceed to a next step.

9. The reservation and notification method according to claim 7, wherein, after the mobile communication device receives the reservation period, the customer preforms one of confirming a reservation, cancelling the reservation, and postponing the reservation, by engaging the mobile communication device.
